(19) United States
(12) Patent Application Publication
(10) Pub. No.: US 2019/0197186 A1
(43) Pub. Date: Jun. 27, 2019

(54) COMPUTER-IMPLEMENTED METHODS, SYSTEMS COMPRISING COMPUTER-READABLE MEDIA, AND ELECTRONIC DEVICES FOR AUTOMATED TRANSCODE LIFECYCLE BUFFERING

(71) Applicant: Mastercard International Incorporated, Purchase, NY (US)

(72) Inventors: Mrutyunjaya Bhattacharjee, Pune (IN); Rajesh Mahalle, Pune (IN); Jerry J. Davis, Wildwood, MO (US)

(73) Assignee: Mastercard International Incorporated, Purchase, NY (US)

(21) Appl. No.: 15/850,866

(22) Filed: Dec. 21, 2017

(51) Int. Cl. G06F 17/30; H04N 21/231; H04N 19/40

(52) U.S. Cl. CPC G06F 17/30858; H04N 21/231; G11B 2020/1075; G06F 17/30882; H04N 19/40; G06F 17/3089

(57) ABSTRACT

A computer-implemented method for transcode lifecycle buffering that includes instructing a transcoding service to transcode a video file to generate a transcoded video file. A file path for a storage location of the transcoded video file may be automatically received and automatically stored.

### FIELD OF THE INVENTION

The present disclosure generally relates to computer-implemented methods, systems comprising computer-readable media, and electronic devices for automated transcode lifecycle buffering.

### BACKGROUND

Modern webpages increasingly include multimedia objects, for example to enhance user experience and encourage engagement. A webpage author may incorporate a multimedia object such as a video file into a webpage by referencing, in the HTML markup for the page, an absolute file path (AFP) for the resource storing the video file. The AFP may comprise a universal resource locator (URL), for example “http://www.videosharingplatform.com/v/ahWJylC0BRU.” The AFP may be incorporated into an embed code specifying other information necessary or desired for proper rendering of the video file on the page. For instance, a typical operation for embedding a video in a webpage may include (1) selecting a desired position for the video on the webpage; (2) copying an AFP for the video; and (3) pasting the AFP into a video ID portion of an src attribute field of an <embed> tag or <iframe> element. Alternatively, an AFP may be pasted into a tool for generating an embed code specifying the desired parameters for the video, and the embed code may be pasted in a desired position on the webpage.

Compressed video files are preferred for incorporation into webpages. In a common scenario, an author will select a video file desired for inclusion on a webpage, name the video file, and upload it to a transcoding service or transcoder for conversion to various formats and renditions more suitable for use on webpage(s) and across various devices and media channels. The converted video files may then be stored locally on author resources and/or on a video sharing platform. Where a converted video file is stored by a platform, the author may record the URL corresponding to the storage location as an AFP for use in an embed code (as discussed above).

This background discussion is intended to provide information related to the present invention which is not necessarily prior art.

### BRIEF SUMMARY

Embodiments of the present technology relate to computer-implemented methods, systems comprising computer-readable media, and electronic devices for automated transcode lifecycle buffering. The embodiments may provide increased efficiency, and reduced error, in webpage design and implementation processes that include video files stored on remote third-party servers such as video sharing platforms.

More particularly, in a first aspect, a computer-implemented method for transcode lifecycle buffering may be provided. The method may include instructing a transcoding service to transcode a video file to generate a transcoded video file, and automatically receiving and storing a file path for a storage location of the transcoded video file. The method may include additional, less, or alternate actions, including those discussed elsewhere herein.

In another aspect, a computing device for transcode lifecycle buffering may be provided. The computing device may include a communication element, a memory element and a processing element. The communication element may be configured to provide electronic communication with a communication network. The processing element may be electronically coupled to the memory element and to the communication element. The processing element may be configured to execute a buffer application configured to: instruct a transcoding service to transcode a video file to generate a transcoded video file; automatically receive a file path for a storage location of the transcoded video file; and, automatically store the file path. The system may include additional, less, or alternate functionality, including that discussed elsewhere herein.

In still another aspect, a system comprising computer-readable media for transcode lifecycle buffering may be provided. The system may include a non-transitory computer-readable medium with a program stored thereon, wherein the program instructs a hardware processing element of a device to: instruct a transcoding service to transcode a video file to generate a transcoded video file; automatically receive a file path for a storage location of the transcoded video file; and, automatically store the file path. The program(s) stored on the computer-readable media may instruct the processing elements to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates various components of an exemplary system for automated transcode lifecycle buffering according to embodiments of the present invention in block schematic form;

FIGS. 2 and 3 illustrate various components of exemplary servers shown in block schematic form that may be used with the system of FIG. 2;

FIG. 4 illustrates various components of an exemplary content management computing device shown in block schematic form that may be used with the system of FIG. 2;

FIG. 5 illustrates various components of exemplary user electronic devices shown in block schematic form that may be used with the system of FIG. 2;

FIGS. 6-7 are flowcharts of various components of exemplary systems for automated transcode lifecycle buffering, and of relationships between the components, according to embodiments of the present invention; and

FIG. 8 illustrates at least a portion of the steps of an exemplary computer-implemented method for automated transcode lifecycle buffering according to an embodiment of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Digital asset management software packages generally provide tools for authoring webpages and for centralized indexing and enhanced retrievability of digital assets, such as video files, for use across multiple pages and applications. A typical digital asset management software package may provide one or more templates or other tools to help an author specify and position components while building a webpage. The digital asset management package may be configured to produce embed codes and/or manage embedded video players for optimized user experience. The typical digital asset management software will also offer the option of attaching metadata to the assets—such as tags indicating various aspects of the digital assets—to aid in indexing, searchability and/or retrieval. Exemplary digital asset management software that may be used with embodiments of the present invention is made available, as of the priority date of this disclosure, by Adobe Systems Incorporated under the mark Adobe Experience Manager™.

Commonly, a webpage author will incorporate a video file stored at a remote, third-party server into a webpage. This may include embedding a video player in the webpage and providing an AFP to a memory space on the remote server for use in retrieving the video file at runtime. In many cases, however, the remotely-stored video file must first be transcoded into one or more renditions of the source video file before the embed code may be completed for the webpage. Existing methods for incorporating a video file stored on a third-party server (or other computing device) onto a webpage include selecting the source video file, uploading the source video file to a transcoder, awaiting a notification that transcoding has been completed, and cutting and pasting the new URL or AFP for the transcoded video file(s) into an embed code. Existing methods for embedding video files stored on third-party devices can be time-intensive and subject to significant delays in webpage design to allow for completion of transcoding processes and subsequent retrieval, cutting and pasting of AFP data for transcoded files.

The present embodiments may relate to, inter alia, systems, devices and methods for automated transcode lifecycle buffering that provide increased efficiency, and reduced error, in webpage design and implementation processes that include video files stored on remote third-party servers such as video sharing platforms. Popular video sharing platforms include those provided under the following marks as of the priority date of this disclosure: YouTube®, Youku® and Vimeo®. In an embodiment, a buffer manager automatically processes a selected source video file by: performing file key scraping; directing creation of a transcoded video metadata file and storage of the file key therein; transmitting the source video file to a transcoder with the corresponding file key; receiving a transcode completion notification and file key; automatically obtaining a new absolute or relative file path (referred to herein as “file paths”) for the transcoded video file; automatically updating the metadata file with the file key and the new file path; and enabling a digital asset management application to embed the new file path in a webpage.

In an embodiment, the buffer manager may also direct configuration of the transcoded video metadata file as a local reference folder that may be used by the author in building a webpage before completion of transcoding. For instance, the author may incorporate a reference, pointer, link or the like referencing the reference folder into (and/or in the place of) an embed code on the webpage. In this manner, the author's supporting software (e.g., a digital asset management application or “DAMA”) may automatically refer to the transcoded metadata file—e.g., periodically, continually and/or upon occurrence of specified events such as a request to publish from the author—until the new file path appears, and may replace the reference or pointer with the file path to form a conventional video file embed code.

In an embodiment, the buffer manager may also or alternatively be configured to provide, in conjunction with upload of a source video file to a transcoder, a unique identifier for the source video file to the author and/or DAMA for incorporation as a placeholder within embed code(s) of the author's webpages. The buffer manager may, upon receipt of a file path for the transcoded version of the source video file, be configured to scan the author's webpages for instances of the placeholder and replace same with the file path. In yet another embodiment, the buffer manager may be configured to instruct, in conjunction with upload of a source video file to a transcoder, a third-party server to allocate a specific memory space for the transcoded version of the source video file and to provide a file path for the allocated memory space prior to completion of transcoding of the source video file. The advance file path may be used by the author to embed the transcoded version of the source video file before transcoding is complete. Other means for utilizing file paths provided by a buffer manager are within the ambit of the present invention.

Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

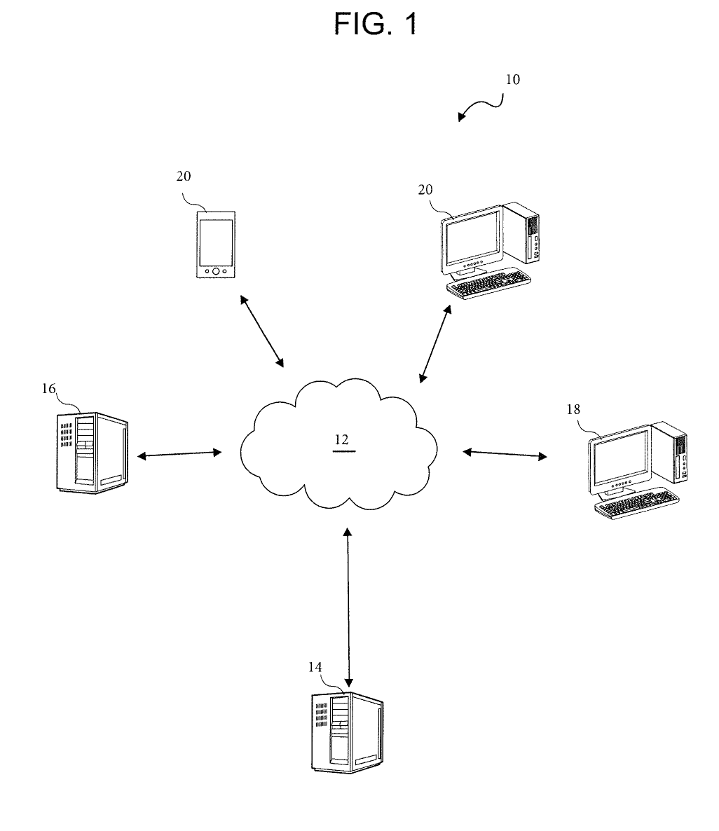

FIG. 1 depicts an exemplary environment in which embodiments of a system 10 may be utilized for automated transcode lifecycle buffering. The environment may include a communication network 12 for enabling communications between components of the system 10. The system 10 may also include a transcode server 14; a remote, third-party storage server 16; and a content management computing device 18 operated by a webpage author.

The webpage author may select source video files stored at the storage server 16 for transmission to and transcoding by the transcode server 14. Once transcoding is complete, the transcode server 14 may transmit one or more transcoded versions of the video file for storage at the storage server 16. The storage location of each transcoded video file at the storage server 16 (i.e., in the form of an AFP or URL) may be transmitted to the content management computing device 18 for use in embed codes of one or more webpages. Webpages incorporating the file paths may be published, and user electronic devices 20 may be used to access and view such webpage(s). That is, the embed code(s) containing the file paths, when executed, may cause the transcoded video file(s) to be accessed from the storage server 16 and displayed on the webpage(s) (e.g., in an embedded player).

Each user electronic device 20 may execute a browser 22 and an operating system 24, transcode server 14 may execute a transcoding application 26, and storage server 16 may execute a video platform application 28.

Broadly, the communication network 12 may allow communication between the user electronic devices 20, the content management computing device 18, and the servers 14, 16. The communication network 12 may include local area networks, metro area networks, wide area networks, cloud networks, the Internet, cellular networks, plain old telephone service (POTS) networks, and the like, or combinations thereof. The communication network 12 may be wired, wireless, or combinations thereof and may include components such as modems, gateways, switches, routers, hubs, access points, repeaters, towers, and the like. For example, the user electronic devices 20 may generally connect to the communication network 12 wirelessly, such as by radio frequency (RF) communication using wireless standards such as cellular 2G, 3G, 4G, or 5G, Institute of Electrical and Electronics Engineers (IEEE) 802.11 standards such as WiFi, IEEE 802.16 standards such as WiMAX, Bluetooth®, or combinations thereof.

Each server 14, 16 generally retains electronic data and may respond to requests to retrieve data as well as to store data. The servers 14, 16 may be embodied by application servers, database servers, file servers, gaming servers, mail servers, print servers, web servers, or the like, or combinations thereof. Furthermore, the servers 14, 16 may include a plurality of servers, virtual servers, or combinations thereof. The servers 14, 16 may be configured to include or execute software such as file storage applications, database applications, email or messaging applications, web server applications, or the like, in addition to and/or in conjunction with software applications 26, 28.

In an embodiment, the transcode server 14 may include a storage and queuing server (not shown) for receiving and prioritizing source video files for transcoding as well for receiving and storing transcoded video files. The transcode server 14 may also include a transcode services server (not shown) for performing file conversion processes such as those outlined herein.

In an embodiment, the storage server 16 may include a front-end server, a video server, a network interface, and various databases including a video database and a publisher account database (not shown). Other conventional features, such as firewalls, load balancers, application servers, failover servers, site management tools, and so forth may also be utilized in conjunction with the storage server 16 but are not shown.

The servers 14, 16 may apply business methods or algorithms, may utilize lookup tables or databases, receive user input via one or more peripheral devices or associated systems, or perform other tasks in connection with the steps outlined herein.

The servers 14, 16 may respectively include communication elements 30, 32, processing elements 34, 36, and memory elements 38, 40.

The communication elements 30, 32 generally allow communication with external systems or devices. The communication elements 30, 32 may include signal or data transmitting and receiving circuits, such as antennas, amplifiers, filters, mixers, oscillators, digital signal processors (DSPs), and the like. The communication elements 30, 32 may establish communication wirelessly by utilizing RF signals and/or data that comply with communication standards such as cellular 2G, 3G, 4G, or 5G, IEEE 802.11 standard such as WiFi, IEEE 802.16 standard such as WiMAX, Bluetooth™, or combinations thereof. Alternatively, or in addition, the communication elements 30, 32 may establish communication through connectors or couplers that receive metal conductor wires or cables which are compatible with networking technologies such as ethernet. In certain embodiments, the communication elements 30, 32 may also couple with optical fiber cables. The communication elements 30, 32 may be in communication with or electronically coupled to memory elements 38, 40 and/or processing elements 34, 36.

The memory elements 38, 40 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory elements 38, 40 may include, or may constitute, a “computer-readable medium.” The memory elements 38, 40 may store the instructions, code, code segments, software, firmware, programs, applications, apps, services, daemons, or the like that are executed by the processing elements 34, 36. The memory elements 38, 40 may also store settings, data, documents, sound files, photographs, movies, images, databases, and the like.

The processing elements 34, 36 may include processors, microprocessors, microcontrollers, DSPs, field-programmable gate arrays (FPGAs), analog and/or digital application-specific integrated circuits (ASICs), or the like, or combinations thereof. The processing elements 34, 36 may generally execute, process, or run instructions, code, code segments, software, firmware, programs, applications, apps, processes, services, daemons, or the like. The processing elements 34, 36 may also include hardware components, such as finite-state machines, sequential and combinational logic, and other electronic circuits that may perform the functions necessary for the operation of embodiments of the current inventive concept. The processing elements 34, 36 may be in communication with the other electronic components through serial or parallel links that include address busses, data busses, control lines, and the like.

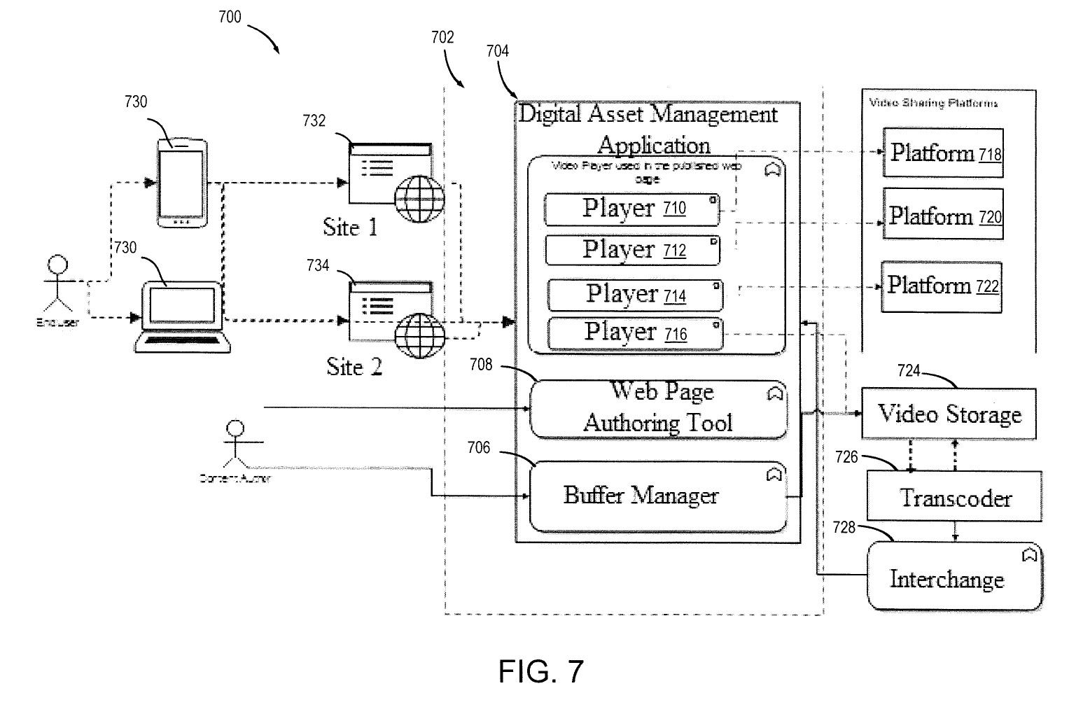

A user electronic device 20 or content management computing device 18 may be embodied by a smart watch, a smart phone, a personal digital assistant (PDA), a tablet, a palmtop or laptop computer, a desktop computer, a notebook, a netbook, smart glasses, wearable and non-wearable electronics (e.g., any IoT device), or other electronic device having computing capacity. The content management computing device 18 may also or alternatively include a web server (e.g., see FIG. 7). A user electronic device 20 may include a GPS receiver element 44, a memory element 48, a processing element 52, software applications 22, 24 and/or a communications element 56, as seen in FIG. 5. The memory element 48 may store the software applications 22, 24, and the processing element 52 may execute the software applications 22, 24. The content management computing device 18 may include a memory element 58, a processing element 60, a communications element 62, a DAMA application 64 and/or a buffer application 66, as seen in FIG. 4. The memory element 58 may store the software applications 64, 66, and the processing element 60 may execute the software applications 64, 66.

The majority of components of each user electronic device 20 or content management computing device 18—more specifically, the communications elements 56, 62, processing elements 52, 60, and memory elements 48, 58—may operate and be constructed according to similar principles and with similar components to those set forth above with respect to analogous components of the servers 14, 16. GPS receivers 44 may operate according to known principles for GPS receivers and/or chips common to smartphones, for example.

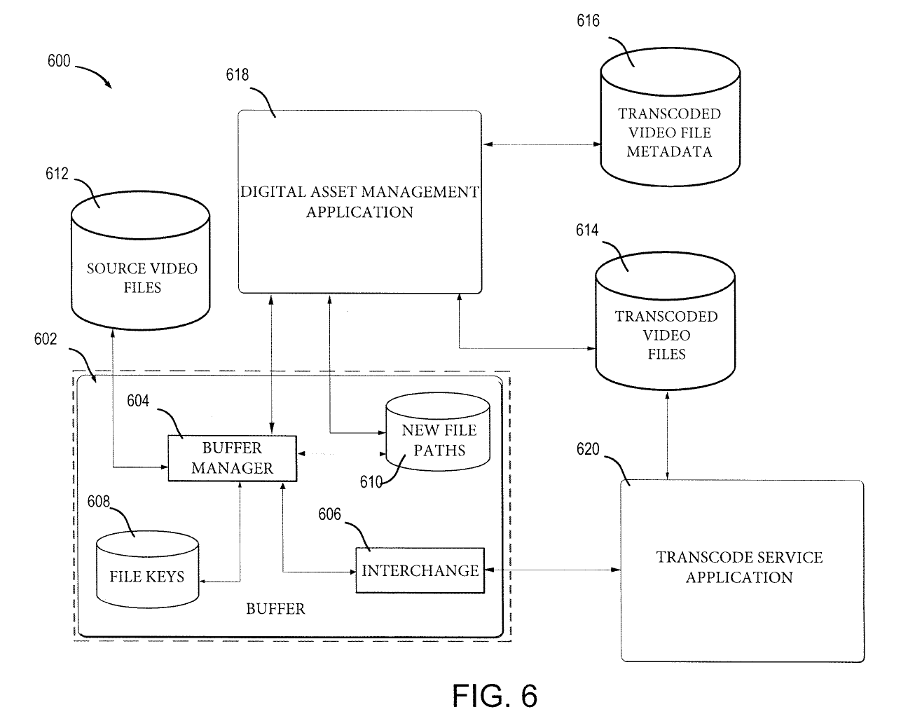

Turning now to FIGS. 6-7, block schematic diagrams are provided illustrating components of exemplary systems 600, 700 for automated transcode lifecycle buffering. The exemplary block diagram 600 illustrates a first embodiment having a buffer application 602 that includes a buffer manager 604, an interchange 606, a file key database 608 and a new file path database 610. The system 600 further includes a source video files database 612, a transcoded video files database 614, and a transcoded video file metadata database 616. The system 600 still further includes a digital asset management application 618 and a transcode service application 620.

The system 700 of FIG. 7 includes a host environment 702 executing a digital asset management application 704. The digital asset management application 704 includes media players 710, 712, 714 and 716. The digital asset management application 704 has also been adapted according to embodiments of the present invention to include a buffer manager 706 and a web page authoring tool 708. The digital asset management application 704 is in electronic communication with video sharing platforms 718, 720 and 722. The digital management application 704 is also in electronic communication with a video storage server 724. An interchange module 728 is in electronic communication with the buffer manager 706 and a transcoder device 726. The interchange module 728 may, for example, maintain communication with the transcoder device 726 via one or more application programming interfaces (APIs). One or more of the APIs may be configured to transmit, and to receive and respond to, data transmissions and/or queries, and to otherwise participate in the processing of automated transcoding lifestyle buffering data under the direction of the buffer manager 706, the interchange module 728 and/or the transcoder device 726. The system 700 also includes user electronic devices 730 and websites 732, 734. The websites 732, 734 include content managed by the digital asset management application 704. It should also be noted that, though not illustrated, the applications of FIG. 7 preferably access and store data to one or more databases in furtherance of the actions outlined herein.

Referring to FIG. 6 and also to the system 10 of FIG. 1, the buffer application 602, transcoded video file metadata database 616, and digital asset management application 618 may reside on the content management computing device 18 and may comprise and/or work in conjunction with DAMA and/or buffer applications 64, 66. In the embodiment of FIG. 7, digital asset management application 704 and, optionally, the interchange module 728, may reside on the content management computing device 18 and may comprise and/or work in conjunction with DAMA and/or buffer applications 64, 66.

Further, in the embodiment of FIG. 6, the transcode service application 620 may reside on the transcode server 14 and may comprise and/or work in conjunction with the transcoding application 26. In the embodiment of FIG. 7, transcoder device 726 and, optionally, the interchange module 728, may reside on the transcode server 14 and may comprise and/or work in conjunction with the transcoding application 26.

Still further, in the embodiment of FIG. 6, the source video files database 612 and transcoded video files database 614 may reside on the storage server 16 and may comprise and/or work in conjunction with the video platform application 28. In the embodiment of FIG. 7, the video storage server 724, and platforms 718, 720, 722 may reside on the storage server 16 and may comprise and/or work in conjunction with the video platform application 28. The video platform application 28 may comprise a database management system managing access to and storage of video files within the aforementioned databases and platforms.

It is foreseen that the aforementioned applications and/or databases and/or their functions described herein may be distributed for execution across various computing devices of a system, and may be co-located on a single device in some cases, without departing from the spirit of the present invention. Moreover, it is foreseen that one or more of the software applications discussed herein may access data of one or more databases with and/or through one or more database management systems, as is commonly known, without departing from the spirit of the present invention.

### Exemplary Computer-Implemented Method

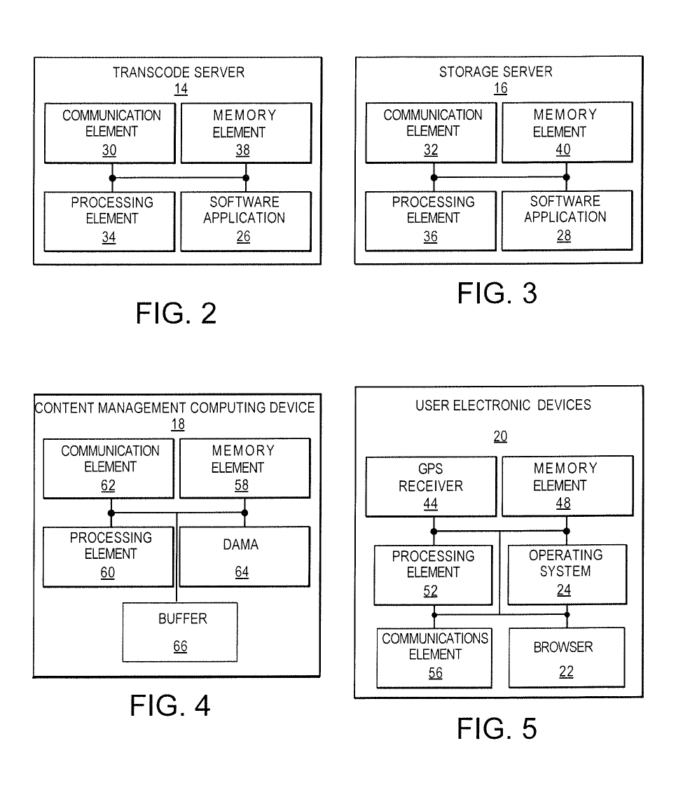

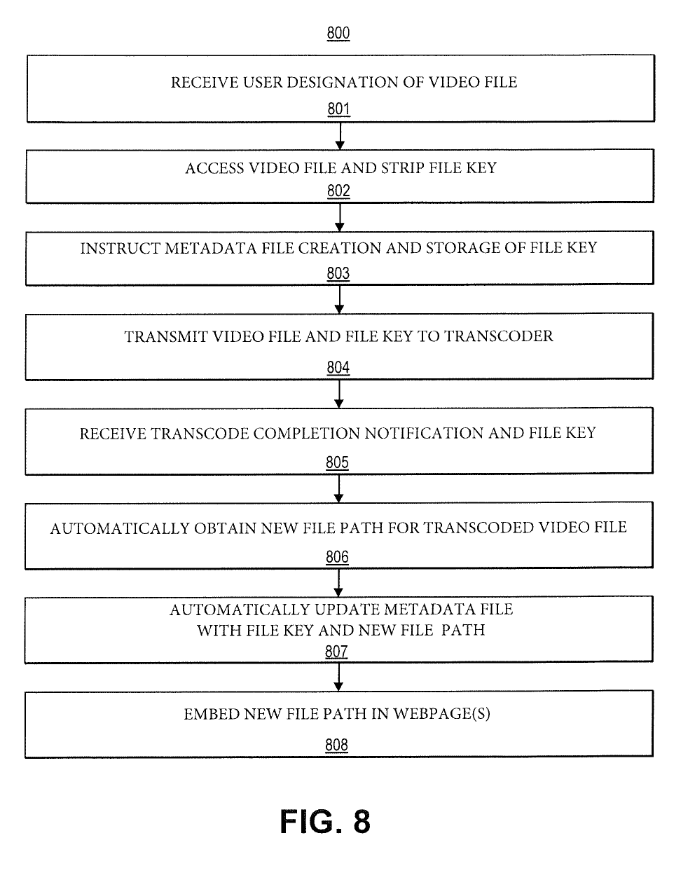

FIG. 8 depicts a listing of steps of an exemplary computer-implemented method 800 for automated transcode lifecycle buffering. Some steps may be performed concurrently as opposed to sequentially, and may in some cases be performed in a different order. In addition, some steps may be optional. The computer-implemented method 800 is described below, for ease of reference, as being executed by exemplary devices and components introduced with the embodiments illustrated in FIGS. 1-7. For example, the steps of the computer-implemented method 800 may be performed by an electronic device 20, content management computing device 18, the servers 14, 16, and the network 21 through the utilization of processors, transceivers, hardware, software (such as the software applications 22, 24, 26, 28, and/or 66), firmware, or combinations thereof. However, a person having ordinary skill will appreciate that responsibility for all or some of such actions may be distributed differently among such devices or other computing devices without departing from the spirit of the present invention. For example, one of ordinary skill will appreciate that one or more of databases 608, 610 and 616 may be combined within the ambit of the present invention. For another example, the storage device of the original source video file may be different from the storage device of the transcoded video file(s) generated from the source video file without departing from the spirit of the present invention. For still another example, one of ordinary skill will appreciate that the video storage server 724 and transcoder device 726 may be co-located within the ambit of the present invention.

One or more computer-readable medium(s) may also be provided. The computer-readable medium(s) may include one or more executable programs, such as a mobile application and a transcoding application, stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 801 and the exemplary components of FIGS. 1 and 6, the buffer application 602 may receive a designation by a user of a source video file. The designation may be received from the digital asset management application 618 or otherwise via user input provided to content managing computing device 18. The designation may include or comprise an absolute file path to the source video file stored within the source video files database 612, and/or the source video file itself. It is foreseen that the designation may comprise the source video file or any form of identification sufficient to enable the buffer application 602 to locate the source video file without departing from the spirit of the present invention. Turning briefly to the embodiment of FIG. 7, step 801 may be performed by the buffer manager 706 and/or the digital asset management application 704 more broadly.

Referring to step 802, the buffer application 602 may access the source video file and/or metadata regarding same and strip or otherwise generate a file key therefrom for storage. Where the designation does not include the source video file, the designated source video file and/or related metadata may be accessed via issuance of a request for same by the buffer application 602 to a database management system comprising an API that controls traffic into and/or out of the source video files database 612 of the storage device 16. It is foreseen that access may be obtained via any number of conventional means within the ambit of the invention.

The buffer manager 604 may be configured to automatically recognize or generate the file key from the designated source video file and/or related metadata. The file key may comprise unique or likely unique identification data associated with the file, and is preferably automatically generated according to one or more pre-defined rules. In an embodiment, the file key may comprise a filename or a combination of the file name and its initial size (i.e., in bytes) upon access at the source video files database 612. The file key may also or alternatively comprise a hash of the contents of the source video file upon retrieval from the source video files database 612. One of ordinary skill will appreciate that any number of ways for generating unique or likely unique identification data from the source video file for use as a file key may be used within the ambit of the present invention. Stripping or generating such a file key automatically according to the configuration(s) of the buffer manager 604 may provide a means for tracing the source video file and/or future converted versions thereof back to the original within the source video files database 612. However, it is also foreseen that other means of generating a unique identification to serve as the file key for the source video file—for example via a pseudo-random number generator or the like—may be employed without departing from the spirit of the present invention.

Turning briefly to the embodiment of FIG. 7, step 802 may be performed by the buffer manager 706 and/or the digital asset management application 704 more broadly, with the video source file being accessed from any one or more of the platforms 718, 720, 722 and video storage server 724.

Referring to step 803, the buffer manager 604 may instruct: (1) creation of a metadata file corresponding to the designated source video file; and (2) storage of the file key. The corresponding metadata file may be stored within the transcoded video file metadata database 616. The transcoded video file metadata database 616 may be managed partly or entirely by the digital asset management application 618. The file key may be stored in the new metadata file of the transcoded video file metadata database 616.

The file key may also or alternatively be stored in the file keys database 608 of the content management computing device 18, for example where the buffer manager 604 does not have easy and/or direct access to the transcoded video file metadata database 616 and/or for purposes of redundancy. More particularly, the buffer manager 604 may generate a new record in the file key database 608 corresponding to the source video file, the new record being primarily keyed using a data field containing the file key. The new record in the file key database 608 may be used internally by the buffer application 602 to track progress through the steps of automated transcode lifecycle buffering according to embodiments of the present invention. As the automated transcode lifecycle buffering steps are completed, the buffer manager 604 may automatically update one or more data fields within the corresponding record to reflect such progress. Once the step(s) are complete and the buffer application 602 has completed all required tasks with respect to a source video file, the buffer application 602 may erase corresponding records maintained in the file keys database 608 and the new file paths database 610, as discussed in more detail below.

Turning briefly to the embodiment of FIG. 7, step 803 may be performed by the buffer manager 706 and/or the digital asset management application 704 more broadly.

Referring to step 804, the buffer manager 604 may transmit and/or direct transmission of the source video file and file key to the transcode service application 620. The buffer manager 604 may update one or more data fields of a corresponding record in the file keys database 608 to reflect completion of the transmission, e.g., by updating a “0” to a “1” in a status field. The buffer manager 604 may also be configured to automatically assign and/or to pass along user instructions regarding a destination for storage of a transcoded video file once complete, and may transmit the destination specification along with the source video file and file key. For example, the buffer manager 604 may automatically pass the source video file and file key (optionally, with transcoded video file destination storage instructions) to the interchange 606 for transmission to the transcode service application 620 of the transcode server 14. It is also foreseen that the source video file may be initially stored on a computing device accessible to the transcode service application, rendering transmission by or at the direction of the buffer manager 604 unnecessary without departing from the spirit of the present invention.

The interchange 606 may comprise an API of the buffer application 602 for exchanging data with the transcode service application 620, for example periodically, continuously and/or as triggered by one or more system 600 events. In an embodiment, the transcode service application 620 may place the source video file in a queue and store same in a storage database to await conversion according to its priority within the queue.

Identification and/or transmission of the source video file to the transcode service application 620 may comprise and/or be accompanied by instruction(s) for transcoding the source video file to one or more desired format(s). Alternatively or in addition, the author, buffer manager 604 and/or digital asset management application 618 may provide such instruction(s) in association with such identification and/or transmission of the source video file.

Turning briefly to the embodiment of FIG. 7, the buffer manager 706 may transmit and/or otherwise identify the source video file and corresponding file key (optionally, with transcoded video file destination storage instructions) to the video storage server 724. The video storage server 724 may place the source video file in a processing queue in accordance with the description above, or may pass the source video file immediately to the transcoder device 726 for conversion. It is foreseen that the buffer manager 706 may utilize a variety of media for transmission of the source video file and file key (optionally, with transcoded video file destination storage instructions) and, ultimately, upload to the transcoder device 726, without departing from the spirit of the present invention.

Referring to step 805, the buffer application 602 may receive a transcode completion notification and the corresponding file key. The buffer manager 604 may update one or more data fields of a corresponding record in the file keys database 608 to reflect completion of transcoding, e.g., by updating a “1” to a “2” in a status field.

In an embodiment, the interchange 606 may monitor and/or receive automated notifications from the transcode service application 620 regarding the source video file by reference to the file key. The buffer manager 604 may direct the interchange 606 to periodically or continuously query the transcode service application 620 (e.g., where configured as an API) for conversion status with respect to the outstanding source video files (e.g., by referencing corresponding file key(s)). The buffer manager 604 may consult the status fields maintained within the file keys database 608 and automatically direct the interchange 606 to inquire regarding those video files having incomplete conversion statuses as reflected by the status field(s).

Again, one of ordinary skill will appreciate that the interchange 606 may consult the transcode service application 620 and/or receive notifications regarding conversion status periodically, continuously and/or as triggered by one or more system 600 events within the ambit of the present invention.

In addition, upon completion of the conversion of the source video file to a transcoded video file, the transcode service application 620 may transmit the transcoded video file and the file key to the transcoded video files database 614 for storage. Other destinations for the transcoded video file and the file key are also within the ambit of the present invention, provided the digital asset management application 618 and/or buffer application 602 are informed of the destination(s) to enable access and use of the file. The destination(s) for the transcoded video file may be as previously specified by the buffer manager 604 (outlined above), otherwise according to instruction(s) received from the digital asset management application 618 and/or buffer application 602 (automatically and/or according user input), and/or as determined according to prior configuration(s) of the transcode service application 620.

Turning briefly to the embodiment of FIG. 7, the interchange module 728 may receive the transcode completion notification and the corresponding file key under step 805 from the transcoder device 726, substantially in the manner outlined immediately above in connection with the analogous interchange 606. In addition, the transcoder device 726 may transmit the transcoded video file and the file key to one or more of the video storage server 724, platform 718, 720, and/or 722 for storage (e.g., via the video storage server 724, interchange 728 and/or digital asset management application 704) substantially in the manner outlined above.

Referring to step 806, the buffer application 602 may automatically obtain a new file path reflecting the new storage location of the transcoded video file. The buffer manager 604 may update one or more data fields of a corresponding record in the file keys database 608 to reflect receipt of the new file path for the transcoded video file, e.g., by updating a “2” to a “3” in a status field.

In an embodiment, the interchange 606 may monitor and/or receive automated notifications from the transcode service application 620 regarding availability of the new file path. For example, the transcode service application 620 may comprise an API configured to provide and/or respond to inquiries regarding new file paths for transcoded video files. More particularly, in an embodiment where the buffer manager 604 maintains one or more status data fields in the file keys database 608 corresponding to each in process source video file, the buffer manager 604 may direct the interchange 606 to periodically or continuously query the transcode service application 620 (e.g., where configured as an API) for new file path(s) for the outstanding source video files whose status data fields reflect that no file path has yet been received (e.g., for each record in which the status field contains a “2”).

The new file path may become available following transmission of the transcoded video file to the transcoded video file database 614, and the new file path is preferably stored by the transcode service application 620 and/or provided with the corresponding file key to the buffer application 602. Once obtained by the buffer application 602, the file path and file key may be stored at least temporarily in the new file paths database 610 of the buffer application 602 in preparation for subsequent processing by the digital asset management application 618 as described below.

Again, it is foreseen that the interchange 606 may consult the transcode service application 620 and/or receive notifications regarding the new file path periodically, continuously and/or as triggered by one or more system 600 events without departing from the spirit of the present invention.

Turning briefly to the embodiment of FIG. 7, the interchange module 728 may receive the file path in conjunction with the corresponding file key under step 806 from the transcoder device 726, and may provide same to the digital asset management application 704, substantially in the manner outlined immediately above in connection with the analogous interchange 606.

It should be noted that, in an embodiment, the transcode completion notification under step 805 and the file path transmission under step 806 may be performed concurrently without departing from the spirit of the present invention. It should also be noted that video files and metadata related thereto may be linked or associated by placement within a common database record, within a common e-mail message, through use of a common key or other unique identifier, or otherwise according to methods known in the art without departing from the spirit of the present invention.

Referring to step 807, the buffer manager 604 may automatically update the metadata file having the corresponding file key within the transcoded video file metadata database 616 to include the new file path. The buffer manager 604 may do so directly or may pass the new file path and the corresponding file key to the digital asset management application 618 for updating of the transcoded video file metadata database 616. The buffer manager 604 may also update one or more data fields of a corresponding record in the file keys database 608 to reflect transfer and storage of the new file path for the transcoded video file, e.g., by updating a “3” to a “4” in a status field. The buffer manager 604 may also clear all records stored in databases 608, 610 for which the foregoing steps of the method 800 have been completed. In an example, all records having a status field populated with a “4” may be deleted every twenty-four (24) hours to clear memory space. The update/transmission/deletion actions outlined above in connection with step 807 may be performed with respect to multiple video files in batches or on a rolling basis without departing from the spirit of the present invention.

Turning briefly to the embodiment of FIG. 7, the buffer manager 706 and/or digital asset management application 704 more broadly may perform the update, transmission and/or deletion steps substantially in the manner outlined immediately above in connection with the analogous buffer application 602.

Referring to step 808, the new file path may be embedded in one or more webpages by the author and/or digital asset management application 618. For instance, the digital asset management application 618 and/or buffer manager 604 may automatically update a list of available digital assets viewable by the author to reflect the availability for use of the transcoded video file and the corresponding new file path stored in the transcoded video file metadata database 616. In an embodiment, the transcoded video metadata file may also or alternatively be configured as a local reference folder. In such an embodiment, prior to receipt of the new file path at step 806, the author may nonetheless build a webpage incorporating the expected transcoded video file, for example by incorporating a reference, pointer or link or the like referencing the local reference folder into and/or in the place of the embed code on the webpage. In this manner, the digital asset management application 618 may automatically refer to the transcoded metadata local reference folder or file—e.g., periodically, continually and/or upon occurrence of specified events such as a request to publish from the author—and replace the reference or pointer with the new file path, once it becomes available according to the steps outlined herein, to form a conventional video file embed code.

In an embodiment, the buffer manager 604 may also or alternatively be configured to provide, in conjunction with upload of a source video file at step 804, a unique identifier for the source video file (such as the file key) to the author and/or the digital asset management application 618 for incorporation as a placeholder within embed code(s) of the author's webpages. The buffer manager 604 and/or digital asset management application 618 may, upon receipt of the corresponding new file path for the transcoded version of the source video file, be configured to scan the author's webpages for instances of the placeholder and replace same with the new file path to complete the author's embed codes.

In yet another embodiment, the buffer manager 604 may be configured to instruct, for example in conjunction with upload of a source video file at step 804, a third-party server (e.g., storage server 16) hosting the transcoded video files database 614 to allocate a specific memory space for the transcoded version of the source video file and to provide a corresponding file path for the allocated memory space prior to completion of transcoding of the source video file and storage of the transcoded version. The buffer manager 604 may be configured to estimate (preferably, conservatively) a compressed file size based on source file size, compressed file format, and other factors, and to provide the estimate to the third-party server to aid in allocating a memory space of appropriate size. The advance file path may be provided to the digital asset management application 618 for incorporation of the anticipated transcoded video file into one or more webpages before the file is even available at the advance file path. Other means for utilizing file paths provided by a buffer manager are within the ambit of the present invention.

Turning briefly to the embodiment of FIG. 7, the buffer manager 706, web page authoring tool 708, and/or digital asset management application 704 more broadly may perform the actions described in connection with step 808 substantially in the manner outlined above in connection with the analogous buffer application 602 and/or digital asset management application 618.

Upon completion of the steps of exemplary method 800, and with reference to the embodiment of FIG. 7, the transcoded video files may be stored at one or more of platforms 718, 720, 722 and video storage server 724. One or more webpages may be published with embed codes incorporating the corresponding file paths. The webpages may include embedded players (e.g., video players 710, 712, 714 and/or 716) compatible with the format(s) of the transcoded video files found at the embedded file paths.

A user electronic device 730 may execute a browser to connect to a front-end server of the host environment 702 via a communication network. The browser may request a webpage including an embed code containing a file path to the transcoded video file(s). The embed code, when executed by the browser, provides a link such as a URL embodying the file path to the embedded player, and the corresponding transcoded video may be obtained for streaming display from a platform 718, 720, 722 or video storage server 724. It is also noted that the embed code in an embodiment also includes additional display parameters, such as the size of the player window, an application type, and the like. It is foreseen that a number of technologies, load and/or file retrieval sequences may be utilized without departing from the spirit of the present invention. It is also well within the capabilities of one having ordinary skill and/or of typical digital asset management software to configure embed codes for dynamic selection of a transcoded video file having an optimal format (e.g., based on device, media channel, etc.), to encode file paths for multiple transcoded video files (sometimes called “renditions”) within a single embed code according to the same objective, or to otherwise optimize and personalize the viewing experience.

Therefore, in an embodiment of the present invention, a website author may embed one or more digital assets immediately following selection of a source video file, and is no longer required to wait long periods of time to obtain a new file path for a transcoded video file for use in embed code(s).

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for transcode lifecycle buffering, comprising:
instructing a transcoding service to transcode a video file to generate a transcoded video file;
automatically receiving a file path for a storage location of the transcoded video file; and
automatically storing the file path.

2. The computer-implemented method of claim 1, wherein the file path is automatically stored in a content management computing device.

3. The computer-implemented method of claim 1, wherein the file path is automatically stored via instruction by a digital asset management application.

4. The computer-implemented method of claim 1, further comprising automatically—
generating a file key corresponding to the video file;
storing the file key in a metadata file;
transmitting the file key to the transcoding service for association with the video file;
receiving the file key in association with receipt of the file path;
storing the file path in the metadata file at least in part by matching the file key in the metadata file.

5. The computer-implemented method of claim 4, wherein the file key is generated based at least in part on metadata regarding the video file according to a pre-defined rule.

6. The computer-implemented method of claim 4, wherein the file key is generated based at least in part on the video file according to a pre-defined rule.

7. The computer-implemented method of claim 6, wherein the pre-defined rule comprises a hashing algorithm.

8. The computer-implemented method of claim 4, wherein a buffer application comprising a buffer manager and an interchange module automatically receives the file path.

9. The computer-implemented method of claim 8, wherein the interchange module exchanges data regarding the video file with an application programming interface of the transcoding service, the exchanged data being identifiable to the video file by reference to the file key.

10. The computer-implemented method of claim 9, wherein the application programming interface of the transcoding service automatically transmits the file key and the file path to the interchange module following generation of the transcoded video file.

11. The computer-implemented method of claim 9, wherein the interchange module automatically queries the application programming interface of the transcoding service by reference to the file key to automatically receive the file path for the video file following generation of the transcoded video file.

12. The computer-implemented method of claim 11, wherein the buffer manager maintains a database comprising records having data fields for file keys and transcode video file status, the buffer manager automatically providing query instructions to the interchange module based at least in part on the transcode video file statuses of the database records.

13. The computer-implemented method of claim 12, wherein the buffer manager periodically automatically instructs deletion of database records for transcoded video files based at least in part on the transcode video file statuses of the database records.

14. The computer-implemented method of claim 1, further comprising—
creating a reference folder corresponding to the video file;
generating a pointer for incorporation into an embed code, the pointer referencing the reference folder,
wherein the file path is automatically stored in the reference folder.

15. The computer-implemented method of claim 1, further comprising generating a unique placeholder corresponding to the video file, wherein the file path is automatically stored by locating and replacing instances of the placeholder with the file path on one or more webpages.

16. The computer-implemented method of claim 15, wherein a buffer manager is configured to automatically locate and replace instances of the placeholder with the file path following automatic receipt of the file path.

17. The computer-implemented method of claim 1, further comprising automatically—
accessing file size metadata regarding the video file;
transmitting the file size metadata to a video platform application;
wherein the file path comprises an advance file path received prior to storage of the transcoded video file in the storage location.

18. The computer-implemented method of claim 17, wherein the storage location has a storage capacity determined at least in part by reference to the file size metadata.

19. The computer-implemented method of claim 1, further comprising transmitting an identification of a storage device prior to receipt of the file path, the storage location being hosted by the storage device.

20. The computer-implemented method of claim 19, wherein the storage device stores the video file and the transcoded video file.
